(19) United States
(12) Patent Application Publication
(10) Pub. No.: US 2026/0105064 A1
(43) Pub. Date: Apr. 16, 2026

(54) ARTIFICIAL INTELLIGENCE MODEL THAT RENDERS DATA VISUALIZATION LAYOUTS BASED ON USERS AND USER DEVICES VIA A THREE-DIMENSIONAL ENGINE

(71) Applicant: Aveva Software, LLC, Lake Forest, CA (US)

(72) Inventor: Maurizio Galardo, Milan (IT)

(21) Appl. No.: 19/359,239

(22) Filed: Oct. 15, 2025

Related U.S. Application Data
(60) Provisional application No. 63/707,216, filed on Oct. 15, 2024.

(51) Int. Cl. G06F 16/26; G06F 11/34; G06F 16/955

(52) U.S. Cl. CPC G06F 16/26; G06F 11/3438; G06F 16/9558

(57) ABSTRACT

An artificial intelligence model is provided that generates data visualization layouts based on users and user devices via a three-dimensional engine. The system collects data which is associated with a user device, browsing behavior of a user of the user device, and at least one data source, in response to receiving a data request associated with the user device. The system analyzes the context of the data associated with the user device, the browsing behavior of the user of the user device, and the at least one data source. An artificial intelligence model adapts a data visualization layout based on the analyzed context of the data and a layout associated with the at least one data source. A three-dimensional engine renders the data visualization layout, which includes data associated with the data request, to the client device.

### CROSS-REFERENCE TO RELATED CASES

This application claims priority to U.S. Provisional Patent Application No. 63/707,216 filed Oct. 15, 2025, which is hereby incorporated herein in its entirety by reference.

### BACKGROUND

In industrial settings, the efficient visualization of data from diverse sources is paramount for informed decision-making and process optimization. However, traditional industrial systems encounter several challenges when visualizing data, leading to inefficiencies and hindered data-driven insights. Industrial sites generate an abundance of data from diverse sources, including sensors, machinery, and control systems. This data is often fragmented, distributed across distinct platforms, and may exist in varying formats, making it arduous to centralize, consolidate, and visualize. Data visualization is essential for enabling users to interact with and interpret large datasets effectively and efficiently.

However, as the complexity and variety of data has increased, existing systems struggle to meet the diverse needs of users and the growing demand for adaptable, cohesive, and high-performance visualization tools. The present disclosure addresses critical limitations and inefficiencies present in current data visualization systems for such heterogeneous data, particularly concerning the integration of data from two-dimensional (2D) and three-dimensional (3D) rendering technologies. For example, current data visualization systems rely on static layouts that do not account for individual user preferences or specific tasks. These layouts typically employ a one-size-fits-all approach, which can hinder effective data interpretation.

Users from different domains, such as data analysts or managers, have unique requirements for how data should be visualized. For instance, analysts may require detailed, granular visualizations, while managers may need simplified, high-level summaries. Current data visualization systems lack the flexibility to adjust to these varying demands, reducing their utility and effectiveness. This lack of adaptability can also overwhelm users with irrelevant information, negatively affecting their ability to focus on critical data points and make timely, informed decisions.

Another significant challenge in current data visualization systems is the fragmentation between 2-Dimensional and 3-Dimensional rendering technologies. In many systems, these two rendering processes operate independently in silos, requiring separate tools, workflows, and user interfaces. This disconnect of data between 2-Dimensional and 3-Dimensional rendering technologies results in inconsistencies in their visual presentations and impairs the ability to create seamless visualizations that leverage both 2-Dimensional and 3-Dimensional rendering. While 3-Dimensional rendering excels in providing depth and realism, important for fields like geographic information systems and simulations, 2-Dimensional rendering is more suitable for simpler, schematic representations like charts and graphs. The failure to integrate these technologies effectively prevents users from fully exploiting the benefits of each, leading to either overly complex or insufficiently detailed visualizations.

Current data visualization systems also face challenges related to the computational resources required for rendering complex 3-Dimensional scenes, especially in real-time environments. The inclusion of high-resolution textures and detailed models further increases the demand for processing power, resulting in slower performance and increased latency, particularly on resource-constrained devices such as mobile platforms and embedded systems. While pre-rendered 2-Dimensional textures can alleviate some of the computational burden, efficiently integrating these textures into dynamic 3-Dimensional environments is technically complex. Furthermore, inefficiencies in data processing pipelines, such as redundant data conversions or suboptimal file formats, exacerbate these performance issues, making it difficult to achieve responsive and detailed visualizations in real time.

Maintaining visual consistency across 2-Dimensional and 3-Dimensional visualizations is another key challenge. Discrepancies between rendering pipelines, such as differences in algorithms and data representation formats, often result in visual inconsistencies. These inconsistencies can confuse users and undermine the credibility of the data being presented, as visual coherence is crucial for ensuring user engagement and understanding.

Ensuring a unified visual language across 2-Dimensional and 3-Dimensional elements is essential for creating intuitive and effective visualizations, but remains difficult to achieve with current technologies.

The development and maintenance of separate systems for 2-Dimensional and 3-Dimensional rendering increase both technical complexity and development costs. Engineers and designers often work with different sets of tools, libraries, and frameworks, leading to duplication of efforts and resource inefficiencies. Additionally, inadequate coordination between teams responsible for different aspects of rendering can result in integration challenges, prolonging development cycles and delaying the release of new features. Consequently, companies may face higher development costs and longer time-to-market, particularly in fast-paced industries where innovation is critical. Furthermore, integration issues can accumulate over time, resulting in technical debt that further complicates system maintenance.

A high-quality user experience is vital for effective data visualization, requiring both functional utility and aesthetic appeal. However, integrating 2-Dimensional and 3-Dimensional rendering technologies often poses challenges that compromise the overall user experience. Users expect seamless interaction, intuitive interfaces, and visually appealing presentations that enhance their understanding of the data. Without a cohesive approach to integrating these technologies, systems often suffer from design inconsistencies, performance issues, and limited adaptability. These shortcomings can frustrate users, resulting in disengagement and lower adoption rates, ultimately reducing the system's effectiveness in meeting its intended purpose.

### BRIEF DESCRIPTION OF THE DRAWINGS

FIG. 1 illustrates a block diagram of an example system architecture for an artificial intelligence model that renders data visualization layouts based on users and user devices via a three-dimensional engine, under an embodiment;

FIG. 2 illustrates a block diagram of an example system for an artificial intelligence model that renders data visualization layouts based on users and user devices via a three-dimensional engine, under an embodiment;

FIG. 3 is a flowchart that illustrates a computer-implemented method for an artificial intelligence model that renders data visualization layouts based on users and user devices via a three-dimensional engine, under an embodiment; and

FIG. 4 is a block diagram illustrating an example hardware device in which the subject matter may be implemented.

### DETAILED DESCRIPTION

An artificial intelligence model is provided that renders data visualization layouts based on users and user devices via a three-dimensional engine. After receiving a data request from a user's device, data is collected from a data source, the device, and about the user. The context of all the collected data is analyzed, and a three-dimensional engine renders the data visualization layout, which includes the system's response to the data request.

For example, after an industrial plant's monitoring system receives a request for financial reports to be sent to the mobile phone of Cleo, the industrial plant's Chief Executive Officer (CEO), the system's data collection module begins collecting data in addition to the plant's financial report, including the technical capabilities of Cleo's mobile phone, Cleo's browsing behavior, explicit preferences, and user profile information. The system's context analysis module applies a machine learning model to identify patterns and trends in the requested data, and analyzes the collected data to understand Cleo's needs and preferences, such as Cleo prefers to view his data in a grid form rather than a list form. The system's personalization engine uses an artificial intelligence model, which is trained to adapt layouts for different user needs, and which takes into account the analyzed data and Cleo's preferences. The system's three-dimensional engine dynamically renders the data visualization layout that presents Cleo's requested industrial plant's financial reports in a grid format that is optimized to fit on Celo's mobile phone screen. Cleo's personal profile indicates that he had worked as an industrial plant equipment repairman years before he became CEO, so the Artificial Intelligence model includes selectable links for 3-Dimensiional videos of malfunctioning plant equipment with Cleo's financial reports, which enables Cleo to review the videos of the malfunctioning equipment and make recommendations that resolve the cause of the malfunction equipment, even though the CEO had no intention of addressing the problem of which he was unaware.

In the industrial and manufacturing fields, diverse data sources are not directly linked by a single platform. Therefore, the disclosed artificial intelligence system provides a novel approach to requesting, searching, retrieving, and/or consolidating data from diverse sources in response to a single information request. The system enriches the data sources using a combination of machine learning and artificial intelligence that identify relevant data and data visualization layouts for individual users. This system overcomes the limitations of currently used static layouts by offering more effective, intuitive and user-friendly data visualization.

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

Although these embodiments are described in sufficient detail to enable one skilled in the art to practice the disclosed embodiments, it is understood that these examples are not limiting, such that other embodiments may be used, and changes may be made without departing from their spirit and scope. For example, the operations of methods shown and described herein are not necessarily performed in the order indicated and may be performed in parallel. It should also be understood that the methods may include more or fewer operations than are indicated. Operations described herein as separate operations may be combined. Conversely, what may be described herein as a single operation may be implemented in multiple operations.

Reference in the specification to “one embodiment” or “an embodiment” or “some embodiments,” means that a particular feature, structure, or characteristic described in conjunction with the embodiment may be included in at least one embodiment of the disclosure. The appearances of the phrase “an embodiment” or “the embodiment” in various places in the specification do not necessarily all refer to the same embodiment.

The disclosed artificial intelligence system enables advanced personalization of data visualization. The system dynamically adapts the data visualization layout based on the specific needs and preferences of each user. The system also enables context adaptability, wherein the data visualization layout is for the user's device, ensuring effective visualization regardless of device type, the personas and the data gathered into the system.

A dynamic data visualization layout provides for an improved user experience in interacting with the data, thereby making the navigation experience more intuitive and satisfying. Furthermore, the use of machine learning and artificial intelligence techniques ensures that the generated data visualization layouts are based on accurate and up-to-date data, increasing the efficiency of data visualization. This disclosed solution overcomes the traditional technical problems by providing a more adaptable, integrated, and efficient data visualization system that seamlessly combines 2-Dimensional and 3-Dimensional rendering technologies.

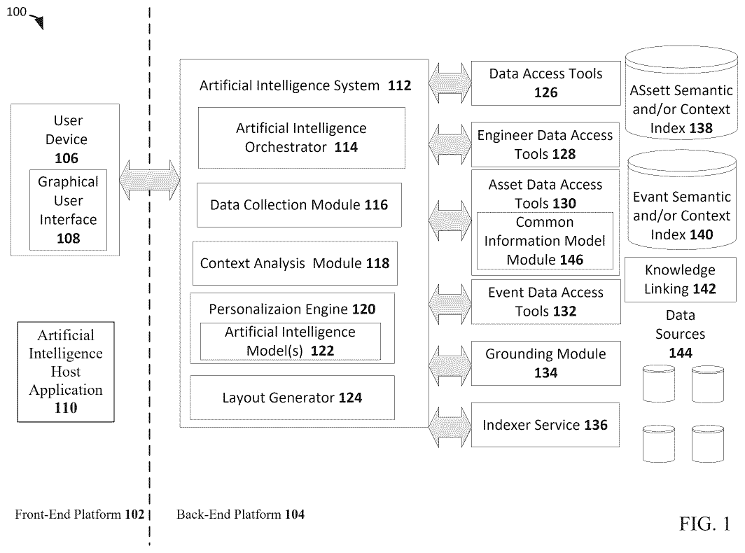

FIG. 1 illustrates an example architecture of the system 100 for an artificial intelligence model that renders data visualization layouts based on users and user devices via a three-dimensional engine, according to some embodiments. The system 100 includes a front-end platform 102 and a back-end platform 104. The front-end platform 102 includes a user device 106 which provides a graphical user interface 108. The graphical user interface 108 is configured or enabled to display data visualization layouts that have been created by the artificial intelligence system 110 in the back-end platform 104 to be personalized and contextual, adapting to the specific devices, needs and preferences of users in real-time. This system 100 overcome the limitations of currently used static layouts by offering more effective, intuitive and user-friendly data visualization.

The graphical user interface back-end platform 104 may be powered by an artificial intelligence host application 110 on the front-end platform 102, which manages and/or facilitates with the collection of relevant data about the user and the context of use. This data may include browsing behavior, which may be referred to as device interactions, explicit preferences, device type used and other pertinent metrics.

The artificial intelligence host application 110 also may manage the inputs with users through the graphical user interface 108. The graphical user interface 108 may enable a user to enter text messages and/or commands, such as through text input fields for users to type messages, and/or areas to display. The artificial intelligence host application 110 receives and/or transmits these user inputs to the back-end platform 104, which includes an artificial intelligence system 112 with an artificial intelligence orchestrator 114 and/or artificial intelligence model(s) 122, as further discussed below.

The artificial intelligence host application 110 may also include features to enhance user interactions, such as buttons that users click on to select predefined options, which help users trigger specific actions. The artificial intelligence host application 110 can also support multimodal inputs, such as voice or images inputs. The artificial intelligence host application 110 may handle error messages or user feedback, forward user inputs, and ensure that the graphical user interface 108 and the back-end platform 104's artificial intelligence system 112 are tightly integrated.

The back-end platform 104 can include the artificial intelligence orchestrator 114 that can manage and/or control the interactions between users/devices and the artificial intelligence system 112. To ensure that graphical user interface 108 displays a personalized visualization of data, the artificial intelligence orchestrator 114 can determine what data is needed to provide to the back-end platform 104. The artificial intelligence orchestrator 114 may receive inputs from the user, such as selection of data to be displayed or an application to run that will provide data to be displayed. The user input may be provided by the user in a conversational manner, such as in a chat bot or in a search bar. In this case, the artificial intelligence orchestrator 114 may execute natural language understanding (NLU) or natural language processing (NLP) techniques to recognize user intents and extract relevant information from the user's device, and link to one or more artificial intelligence models 122 to generate one or more functions described herein.

The artificial intelligence orchestrator 114 may insert and display prompts or suggestions into graphical user interface 108 to a user to encourage the user to provide certain information or take specific actions. For example, if a user is requesting to display data related to a specific pump, the artificial intelligence orchestrator 114 injects prompts to ask for a specific timeframe or different parameters which have status information relating to the pump.

The artificial intelligence orchestrator 114 may execute multi-step transactions by keeping track of the steps in ensuring that all necessary information is collected. The artificial intelligence orchestrator 114 learns from user interactions with the display of data, adapts orchestrator behavior over time, and improves intent recognition and prompt injection strategies based on user input and data.

When responding to a request for data or information, the artificial intelligence orchestrator 114 may interact with application programming interfaces (APIs), external systems, and/or one or more artificial intelligence models 122. When working in conjunction with one or more artificial intelligence models 122, the artificial intelligence orchestrator 114 can use these models to enhance their capabilities to collect information needed to personalize the visualization of the requested data or information. The combination of an artificial intelligence orchestrator 114 and one or more artificial intelligence models 122 provides the benefit of more dynamic and responsive personalized data visualization.

One or more artificial intelligence models 122 (any reference to a single artificial intelligence model is a reference to one or more models) are proficient at understanding requests for data or information. For example, if a user explicitly requests specific data, the artificial intelligence orchestrator 114 uses a large language model's natural language understanding capabilities to interpret user requests, recognize user intents, and/or extract relevant information from a user's device, which helps in determining what the user is asking or trying to achieve. In multi-step transactions, the artificial intelligence orchestrator 114 may instruct the one or more artificial intelligence models 122 to remember and manage the context of the request. The one or more artificial intelligence models 122 may assist in retaining information about the steps completed, a user's preferences, and the state of a transaction, which enables the artificial intelligence orchestrator 114 to seamlessly adapt and change the visualized data displayed based on the user's needs in real-time. The artificial intelligence orchestrator 114 coordinates multiple artificial intelligence models 122, each specialized in a subdomain, such a layout optimization, semantic intent understanding, 3-Dimensional rendering fidelity, thereby maintaining contextual coherence across them.

The one or more artificial intelligence models 122 may also generate a user interface (UI) layout that makes visualization of data relevant, understandable and actionable by taking into consideration user preferences, device information, past interactions, and/or historical data to tailor the display for the individual user. The system 100 can also take into consideration the user's intent. For example, if a user requests display of a set of data types, a user's intent maybe unclear. In this case the artificial intelligence orchestrator 114 may use one or more large language model to generate clarifying questions or suggestions. When encountering information requests or inputs that cannot be handled directly, the artificial intelligence orchestrator 114 can use a one or more large language model to generate appropriate fallback responses, which inform the user of the limitations of the system 100 or encourage them to rephrase their information request.

The artificial intelligence system 112 also includes, at least, a data collection module 116, a context analysis module 118, a personalization engine 120 that uses one of the at least one artificial intelligence model(s) 122, and a layout generator 124. Working together, these components are designed to generate data visualization layouts that are personalized and contextual, adapting to the specific needs and preferences of users in real-time using a 3-Dimensional engine. This system 100 can overcome the limitations of currently used static layouts by offering more effective, intuitive, and user-friendly data visualization.

As described above, the back-end platform 104 includes the artificial intelligence orchestrator 114 that can manage and/or control the interactions between users and the artificial intelligence system 112. To ensure that the graphical user interface 108 displays a personalized visualization of data, the artificial intelligence orchestrator 114 can determine what data is needed to provide to the back-end platform 104. The artificial intelligence orchestrator 114 can collect data related to user interactions with the user device 106. The data collection module 116 tracks user interactions with the user device 106, such as clicks, touch gestures, keyboard inputs, and navigation patterns using the data collected by the artificial intelligence orchestrator 114.

This data may be collected continuously to understand user behavior in real-time. For example, in a smartphone interface, the artificial intelligence orchestrator 114 can continuously collect, and the data collection module 116 can record, when and how often a user utilizes specific applications, how the user scrolls through content, and how long the user spends on particular tasks. Advanced tracking mechanisms, such as eye-tracking sensors or gesture recognition systems, can also be used to gather more nuanced behavioral data, such as where the user's attention is focused on a display screen or how the user physically interacts with the user device 106. This data helps in building a dynamic profile of user preferences, engagement patterns, and common actions.

To collect user behavior data, which may be referred to as device interactions, several essential components may work together to monitor, capture, and process interactions between the user and the system 100 or the user device 106. For example, sensors can track clicks, taps, and gestures on touchscreens or mouse movements on desktop interfaces; key loggers or event listeners track typing patterns, command inputs, and shortcuts; and for mobile devices or smart environments, accelerometers and gyroscopes can capture user movement patterns, such as device tilts, shakes, or physical gestures. Software development kits and Application Programming Interfaces (APIs), such as Google Analytics, Mixpanel, or Firebase, can also be integrated into applications to track specific user behaviors or device interactions, such as application usage, display screen views, website navigation paths, and user engagement metrics; or custom tracking scripts embedded in web or mobile applications can monitor user-specific actions, such as clicks on particular buttons, scroll depths, or time spent on specific pages. Furthermore, real-time events may be monitored using event monitoring services or frameworks are used to capture data from various user interactions. These include clickstream data for web applications, where each interaction is logged in real-time.

Web analytics tools, such as Google analytics, track user navigation patterns, referrer Uniform Resource Locators (URLs), and session durations to understand how users interact with web content. Additionally, eye-tracking devices capture where users are looking on a display screen or within an user interface, providing insight into which elements attract the most attention; microphones or voice input systems (such as speech recognition services like Siri, Alexa) collect audio commands and user preferences based on voice interactions, camera-based systems, such as facial recognition or gesture detection, can capture emotional reactions, eye movements, and other non-verbal cues, particularly for personalized or immersive experiences. Context awareness sensors, such as location-based sensors and environmental sensors, may be used to track a user's physical location, which, when combined with behavior or device interactions data, helps in understanding the user's context for more precise interaction adjustments, and temperature or light sensors can provide additional data for adapting interfaces based on the physical setting. Real-time data processors, such as Kafka or Spark, may be used to handle the continuous influx of data from user behaviors or device interactions, allowing the data to be analyzed or used for personalization immediately.

The data collection module 116 may also collect user device data by monitoring device settings, or context, which may refer to data about the environment in which the user is interacting within the system 100. This includes device-specific settings such as screen resolution, battery status, connectivity status (Wi-Fi, Bluetooth), and geographical location (via GPS). The device data helps in adapting the user interface according to the current state of the user device 106. For example, if the data collection module 116 detects that the user device 106 is in a low-light environment, the data collection module 116 may switch the interface to a dark mode for better visibility, or if the user device 106 is running low on battery charge, the data collection module 116 could suggest power-saving features.

The data collection module 116 may also collect backend data from one or more data sources 140. The artificial intelligence orchestrator 114 may be linked to the data collection module 116 that uses one or more data access tools 126-132, which can access backend data sources 140, such as data from sensors, cameras, and industrial equipment. Alternatively, the data collection module 116 can retrieve or receive backend data directly from the backend data sources 140. Backend data may be gathered from sensor data and other inputs from equipment.

This data can come from multiple sources, such as environmental sensors (temperature, humidity), cameras (used for object detection), or industrial equipment (for process monitoring). In smart environments, data from IoT (Internet of Things) devices, such as motion sensors or industrial machinery, can provide additional context about the user's surroundings and current activity. Additionally, user profile information from databases 140 may be pulled from the backend platform 104 to personalize the experience further. For example, the system 100 might pull user preferences, purchase history, or even biometric data to inform real-time decisions being made regarding the data visualization layout for the graphical user interface 108.

Once the data is collected, the context analysis module 118 processes the collected data and extracts features relevant to identifying patterns. This involves tasks such as behavior or segmentation of the data, identifying contextual features, and determining historical context. Behavior or device interaction segmentation includes grouping interactions into categories based on similarity.

For example, segmentation of device interactions or behavior can include grouping interactions into categories based on similarity, such as frequent application usage, or preferred interaction times,. Identifying contextual features includes understanding user device conditions, such as a user preferring using a specific application at night, or that the use uses power saving mode in low battery situations. Determining historical context includes merging device interactions or behavior with historical data to identify trends over time, such as a user's growing interest in a certain sensor or industrial data type.

Once the relevant features of the collected data are extracted, the context analysis module 118 applies machine learning techniques to analyze the collected data and it's extracted features. Some commonly used approaches include, but are not limited to, clustering, classification, reinforcement learning, and sequential pattern mining. Clustering includes using algorithms like K-means or DBSCAN to group users with similar device interactions or behavior patterns. For instance, users who frequently access specific features or perform similar sequences of actions might be clustered together, thereby allowing the system 100 to personalize the data visualization based on the user's interactions. Classification includes using models such as decision trees or neural networks to classify users into different categories (such as managers and non-managers), enabling the system 100 to adapt the data visualization complexity to each group's proficiency level.

Reinforcement learning includes techniques that allows the system 100 to learn optimal data visualization adjustments by continuously adapting based on feedback loops. If a change in the data visualization improves user engagement, the system 100 can reinforce that device interaction or behavior. However, if the change leads to lower engagement, the system 100 can modify the approach. Sequential pattern mining includes techniques used to detect patterns in the sequences of user actions. For example, the system 100 can identify frequent behavior or device interaction sequences, such as “request data->select the data from the last hour->request data be displayed in a bar graph.” The context analysis module 118 can adapt the data to be visualized in real-time based on the output of these artificial intelligence model(s) 122. For example, if the system 100 recognizes a pattern where the user frequently accesses a particular feature during specific times, the system 100 could proactively request the layout generator 124 to present that feature or tool on the home display screen during those times. If the user device 106 is running low on battery charge, the system 100 could request the layout generator 124 to simplify the data visualization layout to save power. For users who prefer a particular layout, the system 100 can rearrange elements accordingly.

The context analysis module 118 incorporates feedback loops, where real-time user interactions with the data visualization layout are constantly monitored and used to refine the machine learning models. The system 100 further includes a feedback module that continuously refines the visualization layout parameters based on live user interaction metrics, thereby enabling reinforcement-driven adaptation over time. Over time, the system 100 becomes more accurate in predicting user preferences and needs, offering a highly tailored experience. This approach allows the context analysis module 118 to evolve with the user, continuously refining how it presents information and interacts with the user, ultimately improving engagement and satisfaction by offering a responsive and adaptive interface.

Once the data has been contextualized by the context analysis module 118 using machine learning techniques as discussed above, the personalization engine 120, equipped with one or more artificial intelligence models 122, dynamically determines the data visualization layout for data visualization based on the contextual information, such as user behavior, device interactions, device data, and environmental factors. The personalization engine 120 continuously collects and processes real-time data about how users interact with the user interface 108 and the data, their preferences, and the type of user device 106 they are using. For instance, user behavior or device interactions such as clicks, website navigation patterns, and time spent on different user interface layout elements is combined with contextual data, like screen size, connectivity, and even external factors like location or time of day. This rich collection of data is then fed into the artificial intelligence model 122, which processes it to understand the user's needs, context, and preferences at a granular level.

The artificial intelligence model 122, at the core of the personalization engine 120, is trained on a vast dataset that contains various user interaction scenarios, device conditions, and data presentation methods. This training allows the artificial intelligence model 122 to identify patterns in how different users interact with similar interfaces under different contexts. By learning from these historical patterns, the artificial intelligence model 122 develops the ability to predict the most effective data visualization layout for individual users, whether they need complex, detailed dashboards for in-depth analysis or simplified, high-level views for quick overviews. For example, the personalization engine 120 could present a detailed chart for an analyst using a desktop, while showing a summary version on a smartphone for users in a hurry.

The artificial intelligence model 122 can include a generative component that produces semantic layout representations (such as 3-Dimensional scene graphs), which are then rendered by the layout generator 124. Training can use multi-modal datasets combining textual metadata, prior visualization states, and user feedback. The artificial intelligence model 122 outputs semantic layout descriptors, represented as structured data (e.g., JSON, GLTF, or USD), which the rendering engine interprets to generate visualizations.

Once the artificial intelligence model 122 processes the collected data, the artificial intelligence model 122 generates data visualization layout suggestions based on contextual relevance. If a user frequently engages with certain types of data visualizations (such as bar charts for sales performance), the personalization engine 120, prioritizes these elements. Additionally, the artificial intelligence model 122 takes device capabilities into account, such as by adjusting visual elements to avoid cluttering a small smartphone screen or optimizing the use of space on a larger desktop monitor. The artificial intelligence model 122 continuously learns from user interactions, updating its recommendations to improve its accuracy over time. As the artificial intelligence model 122 receives more input and feedback, the personalization engine 120 becomes more adept at understanding and adapting to each user's unique preferences, ensuring that the data visualization layout is always optimized for the task at hand.

A layout generator 124 is responsible for dynamically translating the determinations made by the personalization engine 120 into real-time data visualization layouts, which are rendered through a 3-Dimensional engine. Based on device interactions, user behavior, contextual data, and device type, the layout generator 124 adapts the structure of the visual elements in ways that ensure optimal viewing and interaction. The layout generator 124 uses the artificial intelligence-driven insights from the personalization engine 120 to decide on the arrangement, scale, and types of visualizations most appropriate for the user's context. This might include adapting the complexity of visual elements, like graphs, charts, or dashboards, based on whether the user is accessing the system 100 on a mobile device, desktop, or an Augmented Reality (AR)/Virtual Reality (VR) headset.

In a 3-Dimensional engine, the layout generator 124 takes into account the unique spatial opportunities that a 3-Dimensional environment offers. For instance, instead of rendering data in flat, two-dimensional tables or charts, the 3-Dimensional engine can render immersive, multi-layered visualizations. Elements such as depth, rotation, or interactive layers enable the user to explore data in more intuitive ways. The layout generator 124 works in conjunction with the personalization engine 120 to ensure these visualizations are placed optimally within the 3-Dimensional space, adjusting the data visualization layout dynamically based on screen size, user interaction patterns, and environmental factors like screen orientation.

The system 100 dynamically adjusts rendering complexity based on user device resource availability and network latency, ensuring optimal visualization performance. The generated data visualization layout is exportable as a standardized rendering format compatible with multiple device ecosystems, including augmented and virtual reality environments. The system 100 provides device-agnostic layout rendering through a universal interface layer supporting deployment across heterogeneous environments, including web-based, native, and immersive platforms.

The layout generator 124 also ensures that the design is responsive to different user needs. For manager level users, it might display simplified, high-level summaries, while for analyst level users, it could present more detailed, interactive data sets that allow for deep analysis. This adaptability is key to the system's flexibility, ensuring that the visualizations are effective whether viewed on a small mobile device, a high-resolution desktop screen, or within an immersive virtual reality experience. Additionally, the layout generator 124 optimizes loading times and interactivity, so that even complex data visualization layouts perform efficiently on devices with lower computational power. The combination of personalization and 3-Dimensional rendering allows the system 100 to provide a visually appealing, contextually relevant experience that enhances both usability and data comprehension across various platforms and devices.

The user device 106 includes a user interface 108 that can communicate with the backend platform 104. A user may be able to explicitly request data to be visualized or can select a software application to execute that will automatically provide data to be visualized through the user interface 108. The user request for data to be visualized may be sent to the data collection module 116.

In response to receiving the data to be visualized, the data collection module 116 can send a request to the user device 106 for user interaction data, user device data, and/or explicit user preferences to the user device 106. To retrieve the user interaction data and/or device data from the user device 106, a client-side application running on the user device 106 can collect and transmit the data to the data collection module 116. The user request for the data to be visualized can include device interactions or user behavior data, device data associated with the user device 106, and/or explicit user preferences. The data collection module 116 will also collect data from one or more data sources 140.

After user interaction data, device data, and data source data has been collected, the context analysis module 118 analyzes the collected data, using machine learning algorithms, to identify patterns and trends that influence data visualization layouts generation. The personalization engine 120 uses one or more artificial intelligence models 122 to determine the most suitable data visualization layouts for the specific user. This process takes into account the analyzed information and user preferences. The artificial intelligence models 122 are based on deep neural networks trained on a vast dataset that includes various usage scenarios, user preferences and possible “status” of the data from the backend platform 104.

The context analysis module 118 uses reinforcement learning techniques to continuously improve its performance based on user feedback. Once a suitable data visualization layout for the specific user is determined, the layout is then dynamically generated by the 3-Dimensional engine, taking into account the specific characteristics of the user device 106 and personalized preferences of the user. Once a data visualization layout is generated by the layout generator 124, it is sent to the user device 106 to be displayed on the user interface 108.

As the user interacts with the data visualized in the generated data visualization layout on the user interface 108, the interaction data may be stored on the user device 106 or collected/monitored by the data collection module 116. The artificial intelligence system 112 will update the data visualized on the generated data visualization layout in real-time based on the user's interaction with the data. The user may request the data visualized on the generated data visualization layouts be changed. For example, the user may request that different data be presented, the granularity of the data be changed, or the data visualization layout of the data be altered. Based on this request, the artificial intelligence system 112 will alter or generate a new data visualization layout to visualize the data and provide the altered or new layout to the user interface 108.

The artificial intelligence system 112 offers numerous advantages over traditional data visualization methods. These advantages may be divided into several categories, including personalization, adaptability, efficiency and improved user experience. One of the main advantages of the system 100 is the ability to personalize data visualization layouts based on the data in the backend platform 104, specific user preferences, and user needs. Although modifying the data visualization layouts associated with a system user may be most accurately described as personalizing the data, modifying a data visualization layout based on user device features or historical data may be indirectly understood as being a personalization. Consequently, modifying the data visualization layouts associated with a system user may be more accurately described as a customization, which includes personalization, but also includes modifying data visualization layouts based on user device features and historical data. Using advanced artificial intelligence and machine learning techniques, the system 100 can thoroughly analyze user data, including explicit preferences and browsing behavior. This enables the generation of data visualization layouts that are not only visually appealing but also highly relevant and useful for the end user.

Additionally, the system 100 is designed to be highly adaptable to the context in which it is used. The system 100 can personalize data visualization layouts for a wide range of user devices, from desktops to mobile devices, ensuring that data is always presented in the most effective way possible. The system's adaptability means can respond in real-time to changes in user behavior, device interactions, data behind the system 100, and usage conditions, always providing the most appropriate data visualization layouts for each situation.

The dynamic adaptation of data visualization layouts helps to significantly improve the user experience. Users can interact with data more intuitively and satisfyingly since the data visualization layout is designed to respond to their specific needs and preferences and with more semantic elements to provide feedback and information depth, which leads to greater engagement, better data understanding, and ultimately higher user satisfaction.

Using artificial intelligence models 122 and machine learning algorithms, the system 100 can analyze large amounts of data in real-time and generate data visualization layouts with superior precision and efficiency compared to traditional methods. This not only reduces the time and resources needed to create data visualization layouts manually, but also ensures that the data visualization layouts are always based on the most up-to-date and relevant data. The system 100 is also highly scalable and may be used in a variety of contexts, from individual users to large organizations, and can handle a wide range of data types and adapt to different use cases, making it a versatile solution for data visualization layouts.

The artificial intelligence orchestrator 114 may also be linked to one or more data access tools 126-132, which can access, for example, timeseries data, assets data, event data, engineering data, and the like. The back-end platform 104 may include a grounding module 134 to connect and/or link information from one or more data access tools 126-132 to formulate common understanding that the artificial intelligence orchestrator 114 can work with.

For example, in many systems, 2-Dimensional and 3-Dimensional data access tools (such as rendering technology tools) 126-132 in silos, with separate workflows, tools and processes. This fragmentation leads to inconsistencies and difficulties in creating cohesive visualizations that seamlessly integrate both types of rendering. 3-Dimensional rendering provides depth and realism, useful for certain types of data visualization, such as geographic information systems and simulations. Conversely, 2-Dimensional rendering is often more suitable for flat, schematic representations like charts and graphs. The lack of integration between 2-Dimensional and 3-Dimensional data access tools creates barriers to leveraging the strengths of both in a unified manner. This disjointed approach can result in data visualizations that are either overly complex or insufficiently detailed, failing to provide a clear and comprehensive view of the data. Users may have to switch between different tools and interfaces to access 2-Dimensional and 3-Dimensional visualizations, leading to a fragmented user experience and increased cognitive load.

The artificial intelligence orchestrator 114 can link to both the 3-Dimensional and 2-Dimensional data access tools to access the 2-Dimensional and 3-Dimensional data. The grounding module 134 can connect and/or link information from the 3-Dimensional and 2-Dimensional data access tools 126-132 to formulate common understanding that the artificial intelligence orchestrator 114 can work with to enable creation of a personalized or data visualization display layout. A unified rendering interface enables bidirectional conversion between 2D assets and 3D representations via shared semantic mapping or procedural texture generation.

The artificial intelligence orchestrator 114 can send one or more queries and/or information requests in the back-end platform 104 to retrieve specific data from the data access tools 126-132. For example, the artificial intelligence orchestrator 114 requests a timeseries data access tool 126 to provide historical information, an engineer data access tool 128 to get information about the people or teams involved with an asset or a service, an asset data access tool 130 to access details about products or services, and/or an event data access tool 132 to understand recent occurrences. After the data is retrieved, the artificial intelligence orchestrator 114 can use one of the one or more artificial intelligence models 122 to generate a personalized data visualization layout based on personalized and contextual information obtained by the artificial intelligence orchestrator 114 from the user device 106 and/or other sources, such as user profiles. The artificial intelligence orchestrator 114 continuously and/or periodically monitors real-time events or status changes and/or updates the visualized data with the changes. For example, when a user requests a visualization of data related to the past and present status of the pressure in a pipeline, the artificial intelligence orchestrator 114 may use the event data access tool 130 to provide live updates substantially as they occur.

One or more of the data access tools 126-132 may be linked to an indexer service 136. The artificial intelligence orchestrator 114 uses the indexer service 136 to search and retrieve data quickly from one or more data access tools 126-132, and to organize and categorize data. The system 100 may also use one or more semantic indexes 138-140 for knowledge linking 142, which includes the process of connecting or associating data and information from the different data access tools 126-132 and/or services. The artificial intelligence orchestrator 114 leverages the semantic indexes 138-140 to link knowledge across the data access tools 126-132 for data such as timeseries, engineering, assets, and events.

For instance, the artificial intelligence orchestrator 114 uses the asset semantic index 138 to identify assets, understand their status, and/or provide information about their current condition and/or historical data. An example asset data access tool 130 includes a common information model module 146. The system 100 provides a holistic view of different and/or disparate data sources, such as asset management, from historical performance data to engineering specifications, current asset status, and real-time events, and ensures that users receive comprehensive and context-aware data visualization layout.

The system 100 may execute a combination of semantic search techniques to enable information in different systems to be linked dynamically based on similar attributes, without requiring specific linking data or the usage of same terminology between systems. Additionally, the system 100 may execute a combination of semantic data and vector embeddings to enrich data from one or more databases 140. This enables the system 100 to take generalized phrases as inputs for the one or more large language model(s) 120 that understand the context and objectives of a user's data visualization request, and then generate a vector embedding that represents the user's data visualization request and is similar to the vector embeddings that represent relevant data.

Vector embedding, also known as vector representation or word embedding, includes one or more techniques used by the system 100 in machine learning to represent words, phrases, or documents as numerical vectors. The system 100 generates vectors to capture the semantic meaning and relationships between words, enabling the system 100 to process and understand textual data more effectively. The system 100 also generates one or more vector embeddings that provide distributed representations for words, where words with similar meanings or usages have similar vector representations.

When different systems or tools communicate with one or more artificial intelligence model(s) 122, each system typically has their own specific terms or terminology for concepts, actions, or data. The use of common prompt descriptions enable these systems to respond to information requests or queries in a standardized format that the one or more one or more artificial intelligence model(s) 122 understands. Using common prompts enables the system 100 to achieve a higher level of interoperability.

Implementing common prompts enables different parts of a system or multiple systems to communicate effectively without being hindered by differences in syntax, language, format or terminology, which is beneficial in complex industrial environments where multiple systems need to work together. The common prompt descriptions help eliminate ambiguity or misunderstandings that may arise when different systems use different terms for the same concept. Common or standardized prompts enable the one or more one or more artificial intelligence model(s) 122 to interpret any data request correctly and respond with such a user's intended actions or information.

The use of common prompts streamlines communication between sub-systems. Common prompts reduce and/or eliminate the need for extensive mapping (such as a knowledge graph) or translation processes, making interactions more efficient thereby saving computer resources. In addition to generating common prompts to provide a standardized foundation for communication, the system 100 also adapts and/or extends the common prompts to specific use cases or industries. The system 100 can integrate the extended prompts while still accommodating domain specific terminology. Common prompt descriptions are dynamically extendable through an adaptive mapping engine, ensuring interoperability between artificial intelligence submodules and third-party artificial intelligence systems without manual configuration.

When different systems collect or manage data, common prompt descriptions assist in linking and integrating the different data seamlessly. The common prompts enable the one or more one or more artificial intelligence model(s) 122 to access and process information from various sources without being constrained by data silos. As an industrial setting grows and evolves, the use of common prompt descriptions facilitates scalability. Therefore, new systems or components can easily join the network and communicate with existing systems without significant integration challenges.

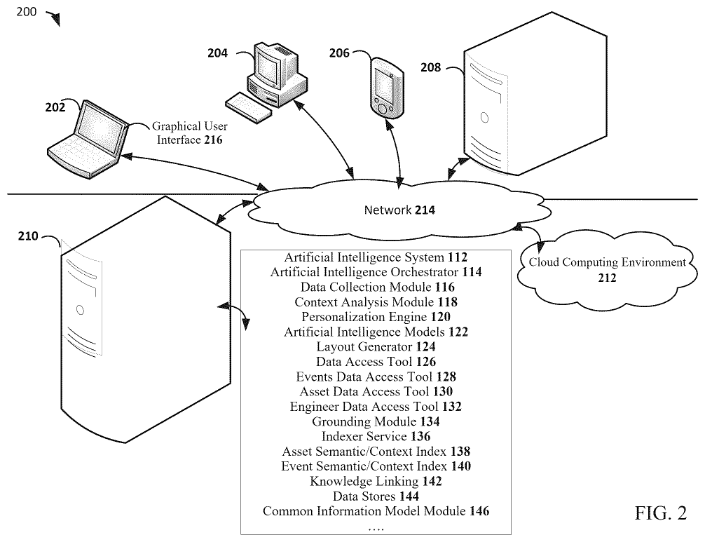

FIG. 2 illustrates a block diagram of an example system 200 for an artificial intelligence model that render data visualization layouts based on users and user devices via a three-dimensional engine, under an embodiment. As shown in FIG. 2, the system 200 may illustrate a cloud computing environment in which data, applications, services, and other resources are stored and delivered through shared data centers and appear as a single point of access for the users. The system 200 may also represent any other type of distributed computer network environment in which servers control the storage and distribution of resources and services for different client users.

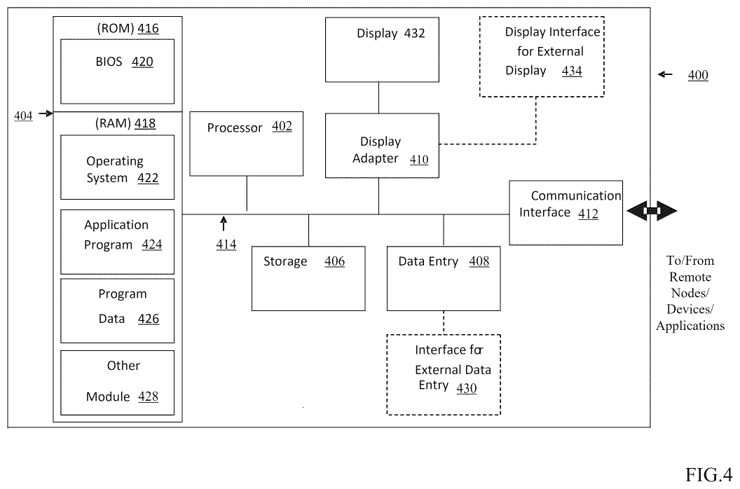

In an embodiment, the system 200 represents a cloud computing system that includes a first client 202, a second client 204, a third client 206, a fourth client 208, and a server 210 and an optional cloud computing environment 212 that may be provided by a hosting company. The clients 202-208, the server 210, and the cloud computing environment 212 communicate via a network 214. Even though FIG. 2 depicts the first client 202 as a laptop computer 202, the second client 204 as a desktop computer 204, the third client 206 as a smart phone 206, and the fourth client 208 as a server 208, each of the system components 202-210 may be any type of computer system, and may each be substantially similar to the hardware device 400 depicted in FIG. 4 and described below.

The server 210 can host and execute components 112-146, which are substantially similar to components 112-146, depicted in FIG. 1 and described in Applicant's Specification in reference to FIG. 1, and which may be accessed via a graphical user interface 216, as depicted by FIG. 2, and/or reside on any of the clients 202-208. Although FIG. 2 depicts all of the system elements 112-146, residing completely on the server 210, any or all of the system elements 112-146 may reside completely on the clients 202-208, completely on the cloud computing environment 212, or in any combination of partially on the clients 202-208, partially the server 210, partially on the cloud computing environment 212, and/or partially on another server which is not depicted in FIG. 2. FIG. 2 depicts the system 200 with four clients 202-208, one server 210, one cloud computing environment 212, one network 214, one graphical user interface 216, and one set of the system elements 112-146, but the system 200 may include any number of clients 202-208, any number of servers 210, any number of cloud computing environment 212, any number of network 214, any number of graphical user interface 216, and any number of system elements 112-146.

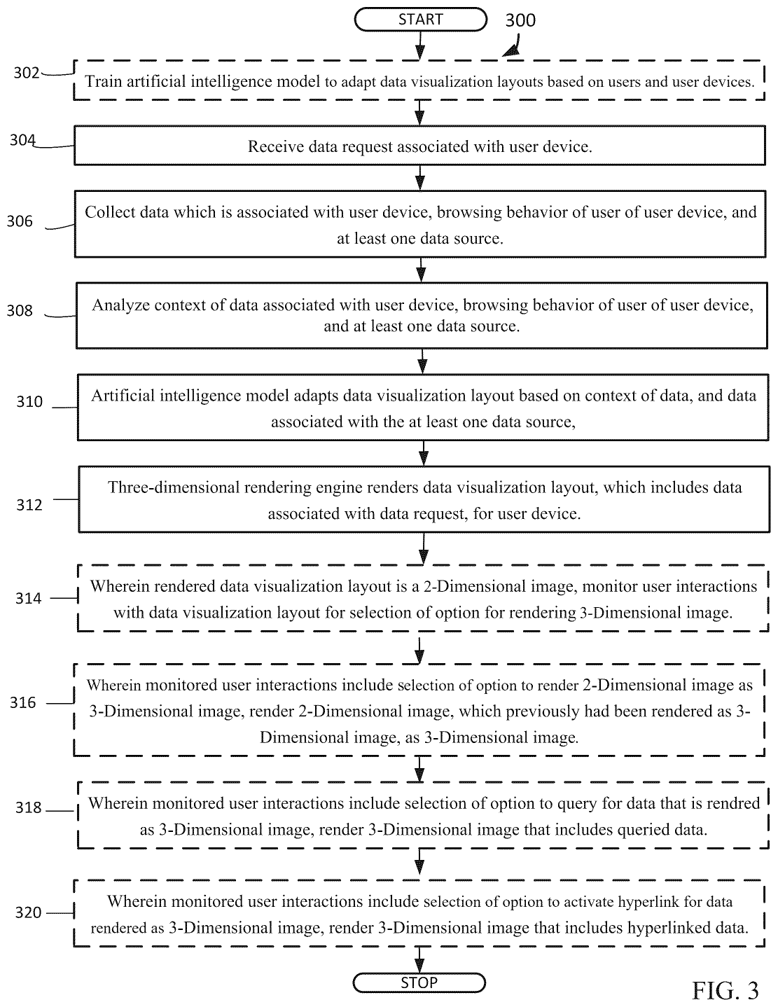

FIG. 3 is a flowchart that illustrates a computer-implemented method for an artificial intelligence model that renders data visualization layouts based on users and user devices via a three-dimensional engine, under an embodiment. Flowchart 300 depicts method acts illustrated as flowchart blocks for certain actions involved in and/or between the system elements 102-146 of FIG. 1.

An artificial intelligence model is optionally trained to adapt data visualization layouts based on users and user devices, block 302. The system can train an artificial intelligence model to adapt data visualization layouts for user devices that request data. For example, and without limitation, this can include the system 100 training the artificial intelligence model 122 on a vast dataset that contains various user browsing behaviors, explicit user preferences, and types of user devices, which identifies historical patterns for how different users interacted with their devices under different contexts, which develops the ability to predict the most effective data visualization layout for individual users.

An artificial intelligence model can be a computer program or algorithm trained on data to recognize patterns and make predictions or decisions. A data visualization layout can be the arrangement and organization of visual elements like charts, graphs, and maps to represent data clearly and effectively. A user can be a person who interacts with a computer. A user device can be any physical hardware component, such as a mouse, printer, or storage drive, that performs a specific function.

After an artificial intelligence model is trained to adapt data visualization layouts foe different users, a data request associated with a user device is received, block 304. The system receives data requests after training is complete. By way of example and without limitation, this can include the system 100 receiving a request for an industrial plant's financial reports from the mobile phone of Cleo, the CEO of the industrial plant. A data request can be an inquiry for specific information from a database or system.

Following the receiving of a data request associated with a user device, data is collected which is associated with the user device, browsing behavior of a user of the user device, and at least one data source, block 306. The system collects the data required to generate a data visualization layout. In embodiments, this can include the data collection module 116 beginning collecting data that includes the industrial plant's financial reports, the technical capabilities of Cleo's mobile phone, and Cleo's browsing behavior, explicit preferences, and user profile information.

Data can be a collection of facts, figures, and symbols represented in a binary digital form that may be processed and stored. A browsing behavior can be the actions and patterns a user exhibits while navigating online content, including how they search for information, interact with content, and move between web pages. A data source can be the origin point where data comes from, which may be a database, a file, or a live feed, and it holds all the necessary information for a program to access that data.

Having collected data which is associated with a user's device, browsing behavior of a user of the user device, and a data source, then the context of the data associated with the user device, browsing behavior of a user of the user device, and the at least one data source are analyzed, block 308. The system analyzes the context of all the collected data. For example, and without limitation, this can include the context analysis module 118 applying a machine learning model to identify patterns and trends in the requested data, and analyzing the collected data to understand Cleo's needs and preferences, such as Cleo prefers to view his data in a grid form rather than a list form. A context can be the necessary information, state, or environment required for a piece of code or an entire system to operate effectively.

After a context is analyzed of the data associated with a user device, browsing behavior of a user of the user device, and a data source, an artificial intelligence model adapts a data visualization layout based on the context of the data, and data associated with the at least one data source, block 310. The system uses the context of all the collected data to adapt the data visualization layout. By way of example and without limitation, this can include the personalization engine 120 using the artificial intelligence model 122 to adapt layouts to different user needs, while taking into account the analyzed data and Cleo's preferences.

Following the adapting of a data visualization layout based on the analyzed context of the user's data, a three-dimensional engine renders the data visualization layout, which includes data associated with the data request, for the user device, block 312. The system uses a three dimensional engine to render the data visualization layout. In embodiments, this can include the three-dimensional engine dynamically rendering the data visualization layout that presents Cleo's requested industrial plant's financial reports in a two-dimensional grid format that is optimized to fit on Celo's mobile phone screen. A three-dimensional engine can be software that converts 3D models into realistic 2D images or animations by simulating light, materials, and cameras.

Having rendered a data visualization layout for the user device, wherein the rendered data visualization layout comprises a 2-Dimensional image, further comprising optionally monitoring the user interactions with the data visualization layout for a selection of an option for rendering a 3-Dimensional image, block 314. The system can send 2-Dimensional images to a user device, and continue monitoring a user's interactions which may request the rendering of a 3-Dimensional image. For example, and without limitation, this can include Cleo's user device responding to the rendered 2-Dimensional financial reports by selecting of an option for rendering a 3-Dimensional image.

An interaction can be systems and software that enable two-way communication between a human user and the computer, where the user provides input (commands or data) and the system responds with immediate results or updated information. A 2-Dimensional image can be a representation of an object or a scene that has length and width, but no depth. A selection can be the action of carefully choosing something as being the best or most suitable. An option can be a thing that is or may be chosen. A 3-Dimensional image can be a representation of an object or a scene that has length, width, and height.

After optionally monitoring user interactions with a 2-Dimensional data visualization layout, wherein the monitored user interactions comprise a selection of an option to render a 2-Dimensional image as a 3-Dimensional image, further comprising rendering the 2-Dimensional image, which previously had been rendered as a 3-Dimensional image, as a 3-Dimensional image, block 316. The system can convert 2-Dimensional images which had been 3-Dimensional images, back into 3-Dimensional images. By way of example and without limitation, this can include the system 100 sending the rendered 2-Dimensional financial reports, which had been converted from 3-Dimensional financial reports when the system 100 detected a low battery charge for Cleo's mobile phone, as 3-Dimensional financial reports because the system 100 detected a full battery charge for Cleo's mobile phone.

Conversion between the 2-Dimensional image and the 3-Dimensiona image is enabled via shared semantic mapping. Conversion can be the process of changing data from one format, type, or representation to another to ensure compatibility, allow for different uses, or prepare it for a new system. Shared semantic mapping can be the process of establishing and utilizing a common understanding of data and its relationships across different systems or contexts.

Following the optional monitoring of user interactions with a 2-Dimensional data visualization layout, wherein the monitored user interactions comprise a selection of an option to query for data that is rendered as a 3-Dimensional image, further comprising rendering the 3-Dimensional image that comprises the queried data, block 318. The system provides 3-Dimensional data images which are requested from 2-Dimensional query images. In embodiments, this can include the system 100 proving the videos of the malfunctioning equipment which Cleo's user device 106 requested while viewing the 2-Dimensional financial reports, which enables Cleo to review and make recommendations that resolve the cause of the malfunctioning equipment.

Having optionally monitored user interactions with a 2-Dimensional data visualization layout, wherein the monitored real-time user interactions comprise a selection of an option to activate a hyperlink for data rendered as a 3-Dimensional image, further comprising rendering the 3-Dimensional image that comprises the hyperlinked data, block 320. The system anticipates a user selecting the rendering of 3-Dimensional images by providing hyperlinks for the 3-Dimensional images. For example, and without limitation, this can include the system 100 sending the hyperlinks for the videos of the malfunctioning equipment to Cleo's user device 106 in anticipation of Cleo requesting to review and make recommendations that resolve the cause of the malfunctioning equipment. A hyperlink can be an element in a computer document that links to another resource.

Although FIG. 3 depicts the blocks 302-320 occurring in a specific order, the blocks 302-320 can occur in another order. In other implementations, each of the blocks 302 - 320 can also be executed in combination with other blocks and/or some blocks may be divided into a different set of blocks.

An exemplary hardware device in which the subject matter may be implemented shall be described. Those of ordinary skill in the art will appreciate that the elements illustrated in FIG. 4 can vary depending on the system implementation. With reference to FIG. 4, an exemplary system for implementing the subject matter disclosed herein includes a hardware device 400, including a processing unit 402, a memory 404, a storage 406, a data entry module 408, a display adapter 410, a communication interface 412, and a bus 414 that couples elements 404-412 to the processing unit 402.

The bus 414 can comprise any type of bus architecture. Examples include a memory bus, a peripheral bus, a local bus, etc. The processing unit 402 is an instruction execution machine, apparatus, or device and can comprise a microprocessor, a digital signal processor, a graphics processing unit, an application specific integrated circuit (ASIC), a field programmable gate array (FPGA), etc. The processing unit 402 may be configured to execute program instructions stored in the memory 404 and/or the storage 406 and/or received via the data entry module 408.

The memory 404 can include a read only memory (ROM) 416 and a random-access memory (RAM) 418. The memory 404 may be configured to store program instructions and data during operation of the hardware device 400. In various embodiments, the memory 404 can include any of a variety of memory technologies such as static random-access memory (SRAM) or dynamic RAM (DRAM), including variants such as dual data rate synchronous DRAM (DDR SDRAM), error correcting code synchronous DRAM (ECC SDRAM), or RAMBUS DRAM (RDRAM), for example.

The memory 404 can also include nonvolatile memory technologies such as nonvolatile flash RAM (NVRAM) or ROM. In some embodiments, it is contemplated that the memory 404 can include a combination of technologies such as the foregoing, as well as other technologies not specifically mentioned. When the subject matter is implemented in a computer system, a basic input/output system (BIOS) 420, containing the basic routines that help to transfer information between elements within the computer system, such as during start-up, is stored in the ROM 416.

The storage 406 can include a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD or other optical media. The drives and their associated computer-readable media provide nonvolatile storage of computer readable instructions, data structures, program modules and other data for the hardware device 400.

It is noted that the methods described herein may be embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media may be used which can store data that is accessible by a computer, such as magnetic cassettes, flash memory cards, digital video disks, Bernoulli cartridges, RAM, ROM, and the like can also be used in the exemplary operating environment. As used here, a “computer-readable medium” can include one or more of any suitable media for storing the executable instructions of a computer program in one or more of an electronic, magnetic, optical, and electromagnetic format, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high-definition DVD (HD-DVD™), a BLU-RAY disc; and the like.

A number of program modules may be stored on the storage 406, the ROM 416 or the RAM 418, including an operating system 422, one or more applications programs 426, program data 426, and other program modules 428. A user can enter commands and information into the hardware device 400 through data entry module 408. The data entry module 408 can include mechanisms such as a keyboard, a touch screen, a pointing device, etc.

Other external input devices (not shown) are connected to the hardware device 400 via an external data entry interface 410. By way of example and not limitation, external input devices can include a microphone, joystick, game pad, satellite dish, scanner, or the like.

In some embodiments, external input devices can include video or audio input devices such as a video camera, a still camera, etc. The data entry module 408 may be configured to receive input from one or more users of the hardware device 400 and to deliver such input to the processing unit 402 and/or the memory 404 via the bus 414.

A display 412 is also connected to the bus 414 via the display adapter 410. The display 412 may be configured to display output of the hardware device 400 to one or more users. In some embodiments, a given device such as a touch screen, for example, can function as both the data entry module 408 and the display 412. External display devices can also be connected to the bus 414 via the external display interface 434. Other peripheral output devices, not shown, such as speakers and printers, may be connected to the hardware device 400.

The hardware device 400 can operate in a networked environment using logical connections to one or more remote nodes (not shown) via the communication interface 412. The remote node may be another computer, a server, a router, a peer device or other common network node, and typically includes many or all of the elements described above relative to the hardware device 400. The communication interface 412 can interface with a wireless network and/or a wired network. Examples of wireless networks include, for example, a BLUETOOTH network, a wireless personal area network, a wireless 802. 21 local area network (LAN), and/or wireless telephony network (e.g., a cellular, PCS, or GSM network).

Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like. In some embodiments, the communication interface 412 can include logic configured to support direct memory access (DMA) transfers between the memory 404 and other devices.

In a networked environment, program modules depicted relative to the hardware device 400, or portions thereof, may be stored in a remote storage device, such as, for example, on a server. It will be appreciated that other hardware and/or software to establish a communications link between the hardware device 400 and other devices may be used.

It should be understood that the arrangement of the hardware device 400 illustrated in FIG. 4 is but one potential implementation and that other arrangements are feasible. It should also be understood that the various system components (and means) defined by the claims, described below, and illustrated in the various block diagrams represent logical components that are configured to perform the functionality described herein. For example, one or more of these system components (and means) may be realized, in whole or in part, by at least some of the components illustrated in the arrangement of the hardware device 400.

In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 4.

Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the descriptions above, the subject matter is described with reference to acts and symbolic representations of operations that are performed by one or more devices, unless indicated otherwise. As such, it is understood that such acts and operations, which are at times referred to as being computer-executed, include the manipulation by the processing unit of data in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have particular properties defined by the format of the data. However, while the subject matter is described in a context, it is not meant to be limiting as those of skill in the art will appreciate that various of the acts and operations described hereinafter can also be implemented in hardware.

To facilitate an understanding of the subject matter described above, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A system for artificial intelligence models that generate data visualization layouts based on users and user devices via three-dimensional engines, the system comprising:
one or more processors; and
a non-transitory computer readable medium storing a plurality of instructions, which when executed, cause the one or more processors to:
collect data associated with a user device, browsing behavior of a user of the user device, and at least one data source, in response to receiving a data request associated with the user device;
analyze a context of the data associated with the user device, the browsing behavior of the user of the user device, and the at least one data source;
adapt, by a trained artificial intelligence model, a data visualization layout based on the analyzed context of the data, and a layout associated with the at least one data source; and
render, by a three-dimensional engine, the data visualization layout, comprising data associated with the data request, for the user device.

2. The system of claim 1, wherein the plurality of instructions further causes the processor to train the artificial intelligence model to adapt data visualization layouts based on users and user devices.

3. The system of claim 1, wherein the rendered data visualization layout comprises a 2-Dimensional image, the plurality of instructions further causes the processor to monitor user interactions with the data visualization layout for a selection of an option for rendering a 3-Dimensional image.

4. The system of claim 3, wherein the monitored user interactions comprise a selection of an option to render a 2-Dimensional image as a 3-Dimensional image, the plurality of instructions further causes the processor to render the 2-Dimensional image, which previously had been rendered as a 3-Dimensional image, as a 3-Dimensional image.

5. The system of claim 4, wherein conversion between the 2-Dimensional image and the 3-Dimensiona image is enabled via shared semantic mapping.

6. The system of claim 3, wherein the monitored user interactions comprise a selection of an option to query for data that is rendered as a 3-Dimensional image, the plurality of instructions further causes the processor to render the 3-Dimensional image that comprises the queried data.

7. The system of claim 3, wherein the monitored user interactions comprise a selection of an option to activate a hyperlink for data rendered as a 3-Dimensional image, the plurality of instructions further causes the processor to render the 3-Dimensional image that comprises the hyperlinked data.

8. A computer-implemented method for artificial intelligence models that generate data visualization layouts based on users and user devices via three-dimensional engines, the computer-implemented method comprising:
collecting data associated with a user device, browsing behavior of a user of the user device, and at least one data source, in response to receiving a data request associated with the user device;
analyzing a context of the data associated with the user device, the browsing behavior of the user of the user device, and the at least one data source;
adapting, by a trained artificial intelligence model, a data visualization layout based on the analyzed context of the data, and a layout associated with the at least one data source; and
rendering, by a three-dimensional engine, the data visualization layout, comprising data associated with the data request, for the user device.

9. The computer-implemented method of claim 8, wherein the computer-implemented method further comprises training the artificial intelligence model to adapt data visualization layouts based on users and user devices.

10. The computer-implemented method of claim 8, wherein the rendered data visualization layout comprises a 2-Dimensional rendering, wherein the computer-implemented method further comprises monitoring user interactions with the data visualization layout for selection of an option for rendering a 3-Dimensional image.

11. The computer-implemented method of claim 10, wherein the monitored user interactions comprise a selection of an option to render a 2-Dimensional rendering as a 3-Dimensional image, wherein the computer-implemented method further comprises rendering the 2-Dimensional image, which previously had been rendered as a 3-Dimensional image, as a 3-Dimensional image.

12. The system of claim 11, wherein conversion between the 2-Dimensional image and the 3-Dimensiona image is enabled via shared semantic mapping.

13. The computer-implemented method of claim 10, wherein the monitored user interactions comprise a selection of an option to query for data that is rendered as a 3-Dimensional image, wherein the computer-implemented method further comprises rendering the 3-Dimensional image that comprises the queried data.

14. The computer-implemented method of claim 10, wherein the monitored user interactions comprise a selection of an option to activate a hyperlink for data rendered as a 3-Dimensional image, wherein the computer-implemented method further comprises rendering the 3-Dimensional image that comprises the hyperlinked data.

15. A computer program product, comprising a non-transitory computer-readable medium having a computer-readable program code embodied therein to be executed by one or more processors, the program code including instructions to:
collect data associated with a user device, browsing behavior of a user of the user device, and at least one data source, in response to receiving a data request associated with the user device;
analyze a context of the data associated with the user device, the browsing behavior of the user of the user device, and the at least one data source;
adapt, by a trained artificial intelligence model, a data visualization layout based on the analyzed context of the data, and a layout associated with the at least one data source; and
render, by a three-dimensional engine, the data visualization layout, comprising data associated with the data request, for the user device.

16. The computer program product of claim 15, wherein the program code includes further instructions to train the artificial intelligence model to adapt data visualization layouts based on users and user devices.

17. The computer program product of claim 15, wherein the rendered data visualization layout comprises a 2-Dimensional rendering, wherein the program code includes further instructions to monitor user interactions with the data visualization layout for selection of an option for rendering a 3-Dimensional image.

18. The computer program product of claim 17, wherein the monitored user interactions comprise a selection of an option to render a 2-Dimensional image as a 3-Dimensional image, wherein the program code includes further instructions to render the 2-Dimensional image, which previously had been rendered as a 3-Dimensional image, as the 3-Dimensional image, and wherein conversion between the 2-Dimensional image and the 3-Dimensiona image is enabled via shared semantic mapping.

19. The computer program product of claim 17, wherein the monitored user interactions comprise a selection of an option to query for data that is rendered as a 3-Dimensional image, wherein the program code includes further instructions to render the 3-Dimensional image that comprises the queried data.

20. The computer program product of claim 17, wherein the monitored user interactions comprise a selection of an option to activate a hyperlink for data rendered as a 3-Dimensional image, wherein the program code includes further instructions to render the 3-Dimensional image that comprises the hyperlinked data.
